(19) United States
(12) Patent Application Publication
(10) Pub. No.: US 2021/0245852 A1
(43) Pub. Date: Aug. 12, 2021

(54) First reducing stage with low thermal conduction elements

(71) Applicant: Mares S.p.A., Rapallo (GE) (IT)

(72) Inventor: Sergio Angelini, Lavagna (GE) (IT)

(21) Appl. No.: 17/168,567

(22) Filed: Feb. 5, 2021

(30) Foreign Application Priority Data
Feb. 12, 2020 (IT) 102020000002761

(51) Int. Cl. B63C 11/22; G05D 16/06

(52) U.S. Cl. CPC B63C 11/2209; G05D 16/0663

(57) ABSTRACT

A first reducing stage for two-stage regulator assemblies includes a first chamber for a high-pressure breathable gas; a second chamber for the breathable gas at an intermediate pressure; a pressure reducing valve connecting the two chambers and having a valve seat with an opening for communication between the two chambers; and a plug cooperating with the valve seat and dynamically connected to a sensor exposed to water to the outer water pressure. The sensor is at least partly accommodated in a housing chamber defined by one or more elements cooperating to provide support and partial movement constraint to the sensor, and forming the housing chamber and/or at least part of the sensor. The one or more elements are made of a material or a combination of materials having thermal conductivity lower than a metal material, and mechanical properties that do not affect correct operation compared to metal materials.

### FIELD OF THE INVENTION

The present invention relates to a pressure reducing device and particularly the first reducing stage for two-stage regulator assembly for use in diving.

### BACKGROUND OF THE INVENTION

Two-stage air pressure and delivery regulating devices are known, for example for underwater use, in which the first pressure reduction stage is connected to a source of high-pressure breathable gas, such as a loaded cylinder normally at 200-300 bar, and is able to reduce the pressure to a predetermined intermediate pressure. The breathable gas at this intermediate pressure is then conveyed, by means of suitable conduits, to a second stage which is responsible for bringing its pressure back to a value compatible with the respiratory organs of the diver in the dive (ambient pressure).

A family of known pressure reducers are the so-called compensated reducers, designed to balance the effect of the additional pressure that the external environment exerts on the device, making the intermediate pressure higher than the ambient pressure by an almost constant value even when the depth in water varies.

Currently there are several variants of compensated first stage types which are divided into two macro-types: one type uses a membrane to transfer the effect of the external pressure on the pressure reduction system while the other type uses a piston in place of the membrane. The membrane system uses a valve (shutter-seat system) distinct from the membrane itself, while in the case of the piston-type systems, the piston itself represents not only the element sensitive to ambient pressure but also the shutter. The present application is addressed to the first stages with independent valve or to the membrane-type first stages, among which, however, there are two particular sub-cases:

A second membrane placed above the main membrane creates an isolated chamber, which can be filled with oil or simply with air, in which case, however, a piston is interposed between the two membranes to transmit the ambient pressure;

The sensor element includes one or even two pistons, such as in the twin balanced piston form. This sub-case actually constitutes a third macro-type and is the subject of patent application IT102018000006613. A first stage of this type differs from what is described above in the case of the piston-type first stages since the piston in this case does not act as a shutter (as instead happens in the piston type first stages) but only as a sensor element of the ambient pressure. As a typology it therefore falls into the category of membrane-type first stages, with the only difference that the membrane is replaced by a piston.

Both sub-cases are aimed at improving the performance of the first stages in very cold waters, which can lead to freezing of the water around the spring and/or the membrane and to create the malfunction of the first stage itself. Both solutions entail a greater complexity of components and an increase in cost, so that it is desirable to find a solution at a lower cost and complexity.

A membrane-type first pressure reduction stage comprises a body provided with an inlet connected to a source of breathable gas at high-pressure and an outlet for the breathable gas at reduced pressure with respect to the pressure of the inlet gas, the body being divided into at least one chamber for the high-pressure gas, communicating with the inlet, and a chamber for the intermediate pressure gas, connected with the outlet, and the intermediate pressure gas chamber communicating with the chamber for the high-pressure gas through a pressure reducing valve.

The pressure reducing valve comprises a valve seat which separates the high-pressure chamber from the intermediate pressure chamber and which cooperates with a shutter, having an enlarged head connected to a stem, so-called piston shutter.

The shutter is housed inside the high-pressure chamber and is axially displaceable, i.e., in a direction parallel to its longitudinal axis, alternatively in both directions, inside the high-pressure chamber, whereby the enlarged head performs alternatively a stroke in the direction of detachment and away from the valve seat and a stroke in the direction of approach and abutment against the valve seat.

A rod is connected with an elastically deformable membrane, which membrane is in contact with water and consequently exposed to the pressure of the external environment and on which an elastic preload acts further. The elastic preload defines, after suitable calibration, the value of the intermediate pressure in addition to the ambient pressure. If at the surface the elastic preload is calibrated to have an intermediate pressure of 10 bar, once the diver drops to 20 meters depth, for example, the intermediate pressure will rise to 12 bar since for every 10 meters of depth there is an ambient pressure increase of 1 bar. This compensation of the intermediate pressure as the depth varies, such that there is always a constant value (10 bar in the example) in addition to the ambient pressure, is very important for the regular functioning of the regulator and is guaranteed by the presence of the membrane, in such a way that the pressure of the external environment and the elastic preload cause an inflection of the membrane itself in the direction of opening of the delivery valve upon inhalation, which deflection is transmitted to the shutter by said rod. The elastic preload is exerted by a spring, whose compression is adjustable by a metal nut (usually chromed brass but can be made of stainless steel, titanium or other) held inside a so-called membrane locking nut, also usually made of chromed brass (but it can be stainless steel, titanium or other) which, as the name suggests, also has the task of fixing the diaphragm on the intermediate pressure chamber. The spring, the membrane locking nut and the adjustment nut, being all above the membrane, are immersed in water.

In its simplest configuration, the shutter is pushed in the closing direction by an elastic preload present in the high-pressure chamber which acts in the opposite direction to the elastic preload acting on the membrane, which preload acting on the membrane in combination with the ambient pressure acting on the diaphragm is overcome by the combination of elastic preload in the high-pressure chamber and intermediate pressure acting on the diaphragm until the shutter reaches the closed position, a situation in which the elastic preload in the high-pressure chamber pressure has no effect in balancing the forces.

When the intermediate pressure is lower than a certain threshold, the sum of the forces acting in the opening direction of the valve prevail over those acting in the opposite direction and the valve opens.

A piston-type first stage, instead of using a diaphragm as an element sensitive to the ambient pressure, uses a piston with an enlarged head, the narrow part of which acts as a high-pressure shutter against a suitable seat, and whose large part defines the chamber intermediate pressure on the one hand and is in contact with water (and therefore influenced by the effects of ambient pressure) on the other. The spring instead of being placed in a separate area as in the case of the diaphragm-type first stage (outside the high-pressure and intermediate pressure chambers) is placed around the piston, immersed in the water, between the high-pressure chamber and the intermediate pressure chamber, in the zone affected by the expansion of the gas and therefore subject to the consequent cooling described below.

Although operating in different modes, both the piston-type first stage and the membrane-type first stage are exposed to strong cooling which can lead, in the case of diving in cold water, to freezing of the water around the spring, in proximity to other moving parts and/or fluid transit passages; this cooling is due to the gas expansion step in the passage from the high-pressure chamber to the intermediate pressure chamber, an expansion which, as is known, is associated with absorption of heat by the Joule-Thompson effect. Although in other contexts this thermodynamic phenomenon is exploited in numerous fields of application, in the context of the present invention this phenomenon and the consequent formation of ice can cause malfunctions and therefore can result even in lethal risks for the diver's health in water.

The contrast to these malfunctions is the reason why the sub-cases described above have been created: they allow to isolate the spring and the membrane from water, replacing it with oil (with a very low freezing point) or air (which does not solidify).

Piston-type first stages are known to be very susceptible to malfunction in cold water precisely because of the position of the spring. In the diaphragm-type first stages, the separation as well as the thermal insulation through the membrane from the intermediate pressure chamber and the distance from the high-pressure chamber makes these first stages congenitally more suitable for diving in cold waters.

Experimental tests carried out by the applicant have also shown that the sub-cases described at the beginning, i.e., with isolation of the spring from the water, and in particular the systems with double balanced pistons (Twin Balanced Piston), are much less exposed to risk of freezing but at the cost of greater constructive complexity. The purpose of this invention is to find an intermediate solution of resistance to cold (higher than the simple standard diaphragm-type configuration but lower than the case of the Twin Balanced Piston or in any case insulation of the spring from the water) with constructive complexity at the same level of the standard diaphragm-type configuration.

The applicant, in the course of various experiments carried out in the field, has been able to find that, at temperatures below 3° C., the common first stage pressure regulators made with a metal body suffer from relatively rapid decay of performance due to the formation of ice due to the cold generated by the expansion of the gas; the heat necessary for expansion is taken from the surrounding areas which, being mainly metallic, are suitable for the transmission of heat (and therefore cold). The observed result is that from 3° C. downwards the formation of ice takes place around the springs and above the mobile elements of the walls, such as the membrane, introducing unwanted friction, stiffening of the elastic elements or even blocking of the spring. As the water temperature decreases, this ice formation obviously occurs more quickly. Finding itself to operate in this circumstance, the first stage presents anomalies in its function of reducing the breathing gas at intermediate pressure such as an increase in intermediate pressure (due to stiffening of the membrane), which can lead to the malfunction of the second stage, or even blockage of the valve in closed or open position due to the formation of ice between the coils of the spring, in both cases with catastrophic consequences.

These negative effects deriving from the low temperature of the water are found to a greater extent in the piston-type first stages due to the position of the spring interposed between the high-pressure chamber and the intermediate pressure chamber or in the heart of the generation of cold and also, albeit to a lesser extent, in the diaphragm-type first stages. For example, it has been experimented that, in extreme conditions of depth and breathing, at temperatures around 1° C., operation stops after a few minutes of operation, demonstrating the limit of this solution even in conditions that a normal diver does not meet.

To a much lesser extent but not to be excluded (but by increasing the duration of regular operation from a few minutes to hours) it is also possible in the variant with double balanced piston as present in the invention subject of patent application oo. 102018000006613 by the same applicant. The double piston system, however, involves an increase in constructive complexity and costs, as well as in weight, so it is desirable to find an intermediate solution that allows an increase in cold resistance compared to the variant with a simple membrane while maintaining constructive simplicity of the variant with simple membrane.

On the other hand, the requests of the users are such as to justify the research and development of innovative solutions that improve the overall performance of the products in question, both in terms of usability and cost. The object of the present invention is therefore to provide a first reducing stage for two-stage dispensing units which is able, by means of a constructively simple solution, to overcome the problems illustrated above with a cold resistance which is intermediate between the variant with simple membrane and the double piston system, ensuring the possibility of avoiding any freezing even in case of use in the environment at temperatures very close to 0° C. and lower than the common values indicated by the reference standards, such as the EN250 standard, further improving or in any case not worsening the overall performance in terms of costs, simplicity and weight.

### SUMMARY OF THE INVENTION

In view of the above, the present invention is advantageous in diaphragm-type first stages and particularly advantageous in the simpler declinations of such devices in which the elastic element or the preload spring in the relative housing chamber is in direct contact with the water. The benefits of this invention are also available from the embodiments where the external pressure sensor includes single or double piston, the present invention being able to result as a further expedient of reducing the transmission of heat and therefore of unwanted formation of ice near or in contact with moving parts and/or of protection against hardening of flexible parts.

The invention achieves the intended aims by means of a first reducer stage for two-stage dispensing units, comprising:

a first chamber for a high-pressure breathable gas, which chamber is or can be connected through an inlet to a high-pressure gas source;

a second chamber for the breathable gas at an intermediate pressure, which intermediate-pressure gas chamber has an outlet for the intermediate-pressure gas and is or can be connected to a user of said intermediate-pressure gas;

a pressure reducing valve, which connects to each other said first chamber and said second chamber, and which valve comprises a valve seat with an opening for the communication between said first and said second chambers, and a plug cooperating with said valve seat and movable from a position closing said pass-through opening to a position opening said pass-through opening, and vice versa,

said plug being dynamically connected to a sensing member exposed to water and thus to the pressure of the environment outside said two chambers, which member comprises a transmission mechanism of the mechanical stress exerted on said sensing member by the pressure of the environment outside the same plug,

said sensor member being at least partially housed in a housing chamber defined by one or a plurality of mutually cooperating elements to provide support and partial movement constraint to said sensor member,

wherein one or more elements forming said housing chamber and/or said sensing member of the pressure of the external environment are made of one material or a combination of materials having thermal conductivity lower than the thermal conductivity of the metal materials, at the same time said one material or a combination of materials having mechanical characteristics such that their use instead of a metal does not affect the overall correct operation.

In a first embodiment, at least one of said elements forming said housing chamber and/or said sensing member are at least partially made of non-metallic substances, such as for example macromolecular- or polymeric-based plastics, in such a way as to guarantee the performance of mechanical resistance to support the stresses to which they are stressed, however limiting the transmission of heat, and therefore the propagation of cold, to the moving elements or to the sensor organ itself.

The use of material with low thermal conductivity has the consequence that, despite the absorption of heat due to the expansion of the gas inside the first stage body, this is not transmitted to the water around the moving elements and/or said sensor member.

In the particular case of the membrane-type system, the membrane itself being made of rubber with one or more layers of nylon inside, already represents a thermal barrier to the transmission of cold from the intermediate pressure chamber to the water. However, the cold is transmitted from the body of the first stage to the element that holds the membrane in position (so-called membrane locking nut), since this element is made of metal and screwed on the main body of the first stage by means of a thread, and consequently transmits the cold to the water just above the membrane, which can then freeze.

By replacing this metal nut with a similar nut made of material with low thermal conductivity, the transmission of cold stops at the interface between the body and the nut and therefore the water above the membrane remains at room temperature. It has been proven that, in extreme conditions where the standard diaphragm configuration ceases operation within 3 minutes and the double piston configuration after over an hour, the variant with a membrane lock nut made of low thermal conductivity material operates correctly for 19 minutes, a 600% improvement without increasing construction complexity.

In the particular case of the double piston system, where the lower piston is made of metal and is placed in contact with the intermediate pressure chamber and therefore feels the cold, the solution consists in replacing the upper metal piston with one made of low conductivity material and, for further improvement, in replacing the upper piston seal ring and the insulation membrane with one made of low thermal conductivity material. In this way, the heat transmission is interrupted at the interface between the two pistons and externally at the point where the ring screws onto the body within which the pistons slide.

The choice of plastic substances is performed by weighing all the technical, economic and implementation aspects to allow the production of devices suitable for the commercial market in which the invention is offered. A preliminary and non-exhaustive list is therefore defined by:

Polyoxymethylene (POM) Acetal Resins

Synthetic polyamides (PA), such as Nylon

Polyphenylene sulphide (PPS)

Polybutylene terephthalate (PBT)

Polyketone (PK)

Liquid crystal polymer (LCP)

Polyether ether ketone (PEEK)

The listed substances can also be used only for part of the components and possibly in any combination between them. Having identified the main novelty of the invention in the use of non-metallic materials, this list is to be considered non-exhaustive and also expandable in the light of new substances that could be defined and/or industrialized in future.

Alternative and/or partially overlapping embodiments provide that said plastic substances include polymeric-based compounds enriched with fibers of plastic or natural material or a combination of the same ones, also known as fiber-reinforced compounds.

In such implementations, the benefit in terms of performance is obtained offered by composite materials in which the basic continuous phase substance, known by the skilled in the art as Matrix, contains a dispersed phase (Reinforcement) and the known combination of these phases is defined to obtain a compound with superior characteristics, where such superior characteristics are exploited to improve the mechanical properties and/or the thermal insulation and thus achieve the aims of the present invention.

It is envisaged that said fiber-reinforced compounds comprise discontinuous phases, even common ones, such as fibers based on glass, carbon fiber or a combination thereof.

Specific forms of the invention that rely on said fiber-reinforced compounds provide for the use of reinforcing fibers in a volumetric percentage up to 50% of the total, with the aim of maximizing the thermal and mechanical performance in accordance with what has already been illustrated for the purposes of construction of pressure reduction devices.

Other specific forms are contemplated in the variants in which said plastic substances include polymers for engineering provided with high physical-mechanical performance, with crystalline or amorphous structure, possibly endowed with thermoplastic characteristics, also known in materials engineering as technopolymers.

### BRIEF DESCRIPTION OF THE DRAWINGS

Additional advantages and features of a device according to the present invention will become evident from the following detailed description of embodiments of the same and, in particular, with reference to two common variants of pressure reduction apparatuses, in which:

FIG. 1 illustrates a diaphragm type and the double piston subtype according to the invention in sectional views; and

FIG. 2 illustrates a diaphragm type and the double piston subtype according to the invention in sectional views.

### DETAILED DESCRIPTION OF EMBODIMENTS OF THE INVENTION

The figures show one of the numerous possible embodiments, by way of non-limiting examples. The benefits of the present invention are also available not only from the two types of reducer presented herein but also from the many devices which include gas expansion chambers and moving elements subject to operating interference due to excessive cooling of the environment in which they operate.

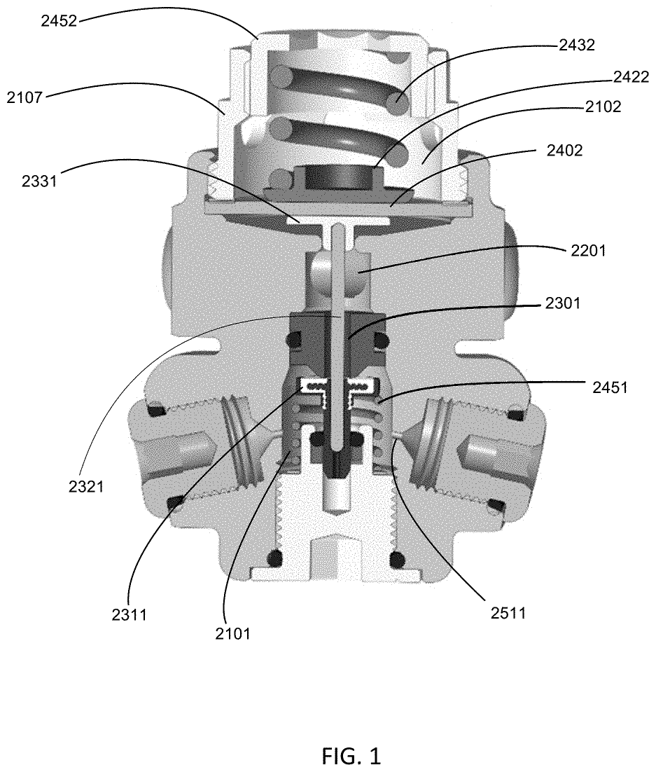

FIG. 1 shows a diaphragm-type first stage according to the known art. In this type of first-stage reducing device of a two-stage dispensing assembly, a membrane 2402 is provided which seals an intermediate pressure chamber 2201 towards the outside environment, which membrane is held in position by the membrane locking nut 2107. The membrane 2402 cooperates on the side exposed to the external environment with a preload spring 2432, which is interposed between an adjustable stationary abutment, for example a threaded preload ring 2452, and a plate 2422 for supporting the membrane 2402 itself. On the side of the membrane 2402 facing the intermediate pressure chamber 2201, the membrane 2402 cooperates with a further plate 2331 which is connected to the shutter 2311 of the reduction valve between the intermediate pressure chamber 2201 and the high-pressure chamber 2101, which is fed from one or more inlets (not visible in the figure) for high-pressure gas. The plate 2331 is connected to the shutter 2311 by means of a rod 2321 which transmits to the shutter the force generated by the external pressure and by the spring 2432 on the membrane 2402. A further elastic element of preload 2451 acts on the shutter 2311.

In this embodiment, the membrane 2402 therefore has both the function of transmitting the pressure of the external environment to the shutter of the pressure reducing valve and the function of sealingly separate the intermediate pressure chamber from the external environment, that is, the fluids present in the intermediate pressure chamber from the outside fluid. The membrane 2402 is secured tightly between two annular clamping stops, one on the main body of the first stage and the other on the membrane locking nut, which cooperate with a peripheral annular band of the membrane itself.

Considering the multiplicity of elements that make up a diaphragm-type first pressure reducing stage in the form as described, which is only one of the possible implementations, an embodiment of the invention provides that at least one or some of the elements described are made with one or a combination of plastic materials having a high thermal insulation, i.e., low heat conduction.

A preferred embodiment comprises, among the elements with low thermal transmission, one or more of the following elements:

membrane locking nut 2107;

preload adjustment ring nut 2452 of the shutter 2311.

In this embodiment, at least one or some or all of said elements are made according to one or more of the innovative features of the invention.

In particular, it is the membrane locking nut which, if made of metal, transmits the cold generated in the main body of the first stage to the water above the membrane and around the spring. By replacing this element with one having low thermal conductivity, the water above the membrane and around the spring is affected in a much lesser way by the cooling so the regular operating time increases significantly.

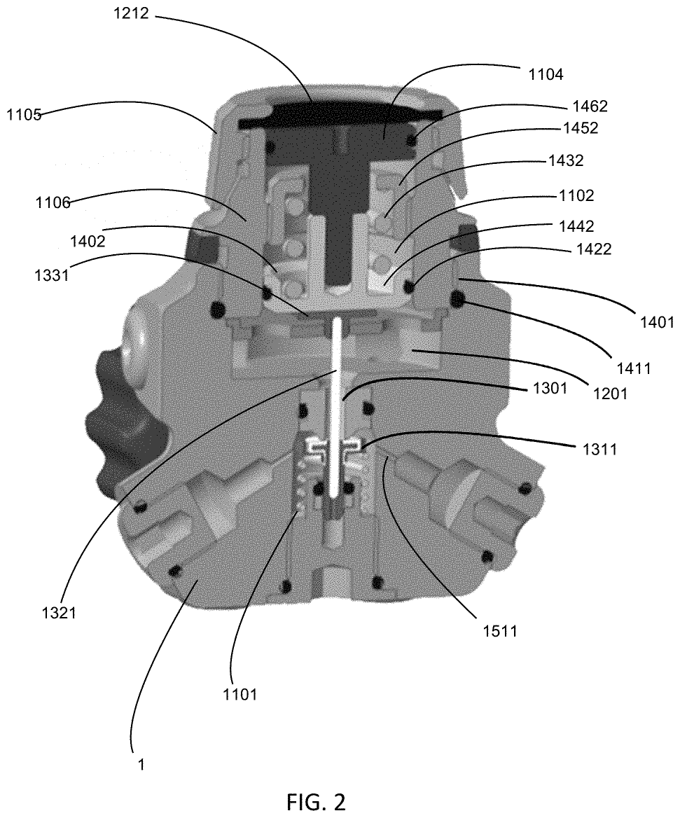

FIG. 2 shows a double piston first stage reducer (subcase of the diaphragm-type first stage). The presence of two pistons can be found in the same FIG. 2, where there is a first piston 1104 exposed to the external environment with sealing to the environment and a second piston 1402 which cooperates with said first piston 1104, moving in common with it inside the housing chamber 1102.

A high-pressure chamber is made in the main body 1, the chamber having one or a plurality of inlets to connect a high-pressure breathing gas source, not shown in the figure and per se known as a high-pressure breathing gas supply cylinder. The seat 1301 of the reduction valve is located in the chamber 1101, which seat opens into the intermediate pressure chamber 1201, and the flow therethrough is regulated by the shutter 1311. The shutter 1311 is connected to a stem 1321, which ends at the opposite end with a plate 1331, inside the chamber 1201. The intermediate pressure chamber 1201 is provided with a plurality of outlets not shown in the figure.

At the top of the intermediate pressure chamber 1201, there is formed a threaded opening 1401 in the body 1 of the first stage, in which opening the block 1106 is screwed, sealed thanks to the gasket 1411. Inside the block 2 there is formed a cylindrical chamber 1102 for housing movable wall elements 1402, 1104. According to the preferred but not exclusive embodiment of FIG. 2, said movable wall elements 1402 and 1104 have a rotational symmetry and are in the form of a circular piston which is movable in the direction of its axis within a rectified section inside the cylindrical chamber 1102.

The movable wall elements 1402 and 1104 slide tightly thanks to peripheral annular seals 1422 and 1462 (the latter optional), along the rectified cylindrical wall. The stroke is limited at least on one side by an end-of-stroke stop in the form of a threaded ring 1105 which acts as a containment for one (in the absence of 1462 on 1104 the diaphragm is not optional) flexible diaphragm 1212, which is alternatively present to said annular gasket 1462, which flexible membrane, when present, adheres to the face of the mobile wall element 1104 facing towards the external environment and interfacing with it.

The opposite end of the stroke is limited by the abutment position of the shutter against a stop in the high-pressure chamber. The two end-of-stroke positions are axially spaced from each other, i.e., spaced one from the other in the direction of movement of the movable wall element 1402. The gasket 1422 is inserted in a toroidal groove provided in the skirt edge of the movable wall element. 1402.

An annular groove 1442 is formed on one face of the movable wall element 1402; this groove has the purpose of cooperating with a helical preload spring 1432. A preload ring 1452 which is screwed to the block 1106, inside the chamber 1102 at a certain axial distance from the movable wall element 1402, constitutes the stationary abutment against which the end of the helical spring 1432 abuts which is opposite to the one resting on the movable wall element 1402.

The rod 1321 which rigidly connects the movable wall element 1402 to the shutter 1311 passes through coaxial holes of the shutter 1311 itself, which forms the end of stoke stop of the piston in the cylindrical chamber 1102 in which said piston 1402 is housed. Advantageously, the rod 1321 is not mechanically connected to the movable wall element, but rests against it, optionally and preferably thanks to an end plate 1331.

Considering the multiplicity of elements that forms a first pressure reducing stage in the form as described, which is only one of the possible implementations, an embodiment of the invention provides that at least one or some of the elements described are made with one or a combination of plastic materials providing high thermal insulation, i.e., low heat conduction.

A preferred embodiment comprises, among the elements with low thermal transmission, one or more of the following elements:

sliding body 1106;

closing member 1105;

preload adjustment organ 1452 of the shutter 1311;

movable piston elements or pistons 1104 and/or 1402.

In this embodiment, at least one or some or all of said elements are made according to one or more of the innovative features of the invention. In particular, if both pistons are made of metal, the cold is transmitted to the membrane 1212, on which ice can form. The cold can also be transmitted from the main body 1 to the sliding body 1106 and from there to the ring 1105, resulting in the formation of ice all around. At the moment, when the membrane 1212 is covered by an important layer of ice, it would no longer be able to effectively transmit the ambient pressure to the upper piston. By replacing one or more of these components with equivalents made of low thermal conductivity material, the already considerable resistance to cold of this system is further increased.

The invention claimed is:

1. A first reducing stage for two-stage regulator assemblies, comprising:
a first chamber for a high-pressure breathable gas, the first chamber being adapted to be connected through an inlet to a high-pressure gas source;
a second chamber for the breathable gas at an intermediate pressure, the second chamber having an outlet for the breathable gas at the intermediate-pressure and being adapted to be connected to a user of the breathable gas; and
a pressure reducing valve connecting to each other the first chamber and the second chamber, the pressure reducing valve comprising a valve seat with an opening for communication between the first chamber and the second chamber, and a plug cooperating with the valve seat and movable from a position closing the opening to a position opening the opening, and vice versa,
wherein the plug is dynamically connected to a sensor exposed to water and to a pressure of an environment outside the first chamber and the second chamber, the sensor comprising a mechanism transmitting a mechanical stress exerted on the sensor by the pressure of the environment outside the plug,
wherein the sensor is at least partly accommodated in a housing chamber defined by one or more elements cooperating with each other to provide support and partial movement constraint to the sensor, and
wherein the one or more elements forming the housing chamber and/or at least part of the sensor are made of a material or a combination of materials having thermal conductivity lower than the thermal conductivity of metal materials, the material or the combination of materials having mechanical properties such that use of the material or the combination of materials in place of the metal materials does not affect a correct operation of the first reducing stage.

2. The first reducing stage according to claim 1, wherein at least one of the one or more elements forming the housing chamber and/or the sensor are at least partially made of a non-metal substance.

3. The first reducing stage according to claim 2, wherein the non-metal substance is a plastic material selected from the group consisting of:
Polyoxymethylene (POM) Acetal Resins,
Synthetic polyamides (PA),
Polyphenylene sulphide (PPS),
Polybutylene terephthalate (PBT),
Polyketone (PK),
Liquid crystal polymer (LCP),
Polyether ether ketone (PEEK),
or a combination thereof.

4. The first reducing stage according to claim 2, wherein the non-metal substance is a plastic material comprising a fiber-reinforced polymer compound.

5. The first reducing stage according to claim 4, wherein the fiber-reinforced compound comprise reinforcing fibers in a volumetric percentage of up to 50% of total.

6. The first reducing stage according to claim 4, wherein the fiber-reinforced compounds comprises glass-based fibers, carbon fibers, or a combination thereof.

7. The first reducing stage according to claim 2, wherein the non-metal substance is a technopolymer.

8. The first reducing stage according to claim 1, wherein the sensor comprises a diaphragm with a preload adjusting mechanism.

9. The first stage according to claim 8, wherein the first reducing stage comprises one or more of the following elements:
a sliding body and/or a membrane-locking body; or
an adjustable stationary element for preload adjustment of the plug.

10. The first reducing stage according to claim 1, wherein the sensor and the housing chamber are of a cylinder/plunger type,
wherein the sensor comprises two movable wall elements rigidly connected to each other, and spaced apart from each other due to mutual connecting members in parallel to a moving direction, one of the movable wall elements providing an interface with the external environment and another one of the movable wall elements providing an interface between the housing chamber of the two movable wall elements toward the second chamber,
wherein the movable wall elements sealingly delimit, respectively towards the external environment and towards the second chamber, an interposition chamber which is insulated from the external environment and from the second chamber, the interposition chamber being a segment of the housing chamber with variable position and having an extension in a sliding direction of the two movable wall elements that corresponds essentially to a distance of the two movable wall elements from each other,
wherein each of the movable wall elements is configured as a plunger housed in the housing chamber that operates as a cylinder, both plungers being sealingly guided along walls of the cylinders due to peripheral sealing gaskets,
wherein both of the movable wall elements is arranged to move inside a respective cylinder in parallel orientation and in a direction of a cylinder axis, the cylinder axis being at least parallel or coaxial to a direction of movement of the plug between the two positions of opening and closing the opening of the valve seat, transmission members being a rod connecting the sensor to the plug,
wherein an axis of the opening of the valve seat is coincident or parallel to the cylinder axis of the cylinder forming the housing chamber of the sensor, the plug being a sealing element mounted on a piston sliding in a cylindrical seat, the piston and the cylindrical seat being parallel or coincident with the axis of the opening of the valve seat and/or with the cylinder axis,
wherein the first chamber, the second chamber, the housing chamber, the valve seat and/or the opening in the seat, the plug and a guide seat thereof, the two movable walls of the sensor, the rod connecting between the sensor and plug all have a rotational symmetry and are coaxial to each other,
wherein the plug is combined with an elastic preload element adjustable via a preload adjusting member,
wherein a preload adjusting member is combined with the sensor, the preload adjusting member being positioned inside the interposition chamber delimited by the two movable wall elements,
wherein, between the two movable wall elements, a flexible membrane is placed and sealingly mounted by a threaded ring nut at an end of the housing chamber of the two movable wall elements, and
wherein at least one or some or all of:
the one or more bodies forming the housing chamber;
the threaded ring nut for sealing the flexible membrane;
the adjusting member of the elastic preload element; or
the plunger interfacing with the external environment,
are made of a material or a combination of materials having thermal conductivity lower than a thermal conductivity of a metal material.
